(19) United States
(12) Patent Application Publication
(10) Pub. No.: US 2006/0045125 A1
(43) Pub. Date: Mar. 2, 2006

(54) Hybrid mobile communication terminal and method of controlling operation mode of the same

(75) Inventor: Myong-Ju Kim, Gunpo-Si (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 11/025,933

(22) Filed: Jan. 3, 2005

(30) Foreign Application Priority Data
Aug. 25, 2004 (KR) 10-2004-0067167

(51) Int. Cl. H04Q 7/24

(52) U.S. Cl. 370/465; 370/338

(57) ABSTRACT

Disclosed are a hybrid mobile communication terminal and a method of controlling operation modes of the terminal. The hybrid mobile communication terminal includes a first communication unit communicating with a first communication system capable of offering voice services and low-speed data transmission, a second communication unit communicating with a second communication system capable of offering high-speed data transmission, and a mode controller for controlling a switching operation between the first and second communication units, wherein the mode controller includes a preference access setup unit which sets so that a data call connection to the first communication system is attempted during a predetermined time interval when the mode controller fails to establish a call connection with the second communication system in a hybrid operation mode in which the mode controller alternately attempts to access the first and second communication systems using the first and second communication units. The method includes the step of attempting to establish a data call connection to a 1× mode during a predetermined time interval upon failure in call connection to an EV-DO (Evolution-Data Optimized) system during a hybrid operation mode.

### BACKGROUND OF THE INVENTION

This application claims the priority of Korean Patent Application No. 2004-67167, filed on Aug. 25, 2004, in the Korean Intellectual Property Office, the disclosure of which is incorporated herein in its entirety by reference.

1. Field of the Invention

The present invention relates to a mobile communication terminal and, more particularly, to a method of controlling an operation mode of a hybrid access terminal (hereinafter referred to as a hybrid terminal) capable of supporting both a voice service and a high-rate packet data service.

2. Description of the Related Art

CDMA2000 is a 3G mobile telecommunications standard, one of the approved radio interfaces for the ITU's IMT-2000 standard, and a successor to 2G CDMA (IS-95). CDMA2000 1× is a development of the CDMA IS-95 standard and the core 3G CDMA2000 technology. CDMA2000 1× service offers high-speed data transmission at up to 144 kbps higher than a conventional data transmission rate of 14.4 kbps or 56 kbps. CDMA2000 1×EV (Evolution) is CDMA2000 1× with High Data Rate (HDR) capability added. CDMA2000 1×EV-DO (Evolution-Data Optimized), a phase of the CDMA2000 1×EV, supports downlink (Forward Link) data rates up to 3.1 Mbps and Up Link (Reverse Link) rates of 154 kbps.

A hybrid access terminal (hereinafter referred to as ‘hybrid terminal’) is a dual-mode access terminal capable of accessing both CDMA2000 1× and 1×EV-DO networks for packet data services. At power up, the hybrid terminal receives an overhead message over a paging channel acting as a control channel of the CDMA2000 1× system and carries out initialization. Subsequently, the hybrid terminal operating in an IS-2000 slotted mode monitors a paging channel in its assigned slot.

Once the hybrid terminal searches for a pilot channel of the EV-DO system and accesses the EV-DO system, it monitors the paging channel of the 1× system and the control channel of the EV-DO system in its assigned slots. In this case, the hybrid terminal is assumed to be in hybrid operation mode. As shown in FIG. 1, the hybrid terminal alternately monitors individual modes at regular intervals of 5.12 seconds.

In the case where the hybrid terminal performs termination or origination of a voice call during the above-mentioned hybrid operation mode, it is switched from the hybrid operation mode to an IS-2000 access mode simultaneously with establishing a call connection with the 1× system. In the case where the hybrid terminal performs termination or origination of a packet call, it establishes an EV-DO packet call and is switched to an IS-856 access mode since an EV-DO mode has been set as a preference access mode.

When the hybrid terminal is required to make a packet call for data communication during the hybrid operation mode, it first tries to establish a session connection with the EV-DO system since the EV-DO mode has been set as a preference mode. As a result, an HDR session negotiation is initiated. In this case, when a propagation environment is deteriorated or a system failure occurs, a base station system transmits a session close message to inform a corresponding terminal of a call-connection failure. When the number of the above-mentioned call-connection failures is equal to or greater than a predetermined number, the hybrid terminal abandons trying to access the EV-DO system and tries to establish a call connection with the 1× system.

The hybrid terminal is switched to a previous operation mode when a voice call or packet call is released. That is, if a packet call is released while the hybrid terminal makes a packet call in the IS-856 access mode, the hybrid terminal returns to the hybrid operation mode. In this case, when a packet call connection is requested again, the hybrid terminal establishes an EV-DO packet call and is switched to the IS-856 access mode since the EV-DO mode is still set as a preference mode. In this case, when a wireless environment is deteriorated or an unexpected failure occurs in the EV-DO system, the hybrid terminal abandons trying to access the EV-DO system after trying the session negotiation several times, and tries to establish a call connection with the 1× system again. Consequently, it takes long time for the hybrid terminal to access the system, resulting in increased power consumption.

In the meantime, power consumption during an idle state in a hybrid terminal is greatly affected by how many times the hybrid terminal wakes up from the idle state. As shown in FIG. 1, the hybrid terminal wakes up from the idle state in a hybrid operation mode two times more frequently than the 1× dedicated terminal. Consequently, the power consumption of the hybrid terminal is twice higher. Further, when it is difficult or not possible to establish a call connection with the EV-DO system, a conventional hybrid terminal monitors both the 1× mode and the EV-DO mode in the hybrid operation mode, which leads to unnecessary power consumption.

### SUMMARY OF THE INVENTION

The present invention provides a method of controlling an operation mode of a hybrid terminal, which is capable of reducing power consumption during an idle state in the hybrid terminal and a time delay caused by a packet call connection.

In accordance with an aspect of the present invention, there is provided a method of controlling call connection of a hybrid mobile communication terminal, comprising the step of: attempting to establish a data call connection to a 1× mode during a predetermined time interval upon failure in call connection to an EV-DO (Evolution-Data Optimized) system during a hybrid operation mode.

The step of attempting to connect to the 1× mode may be carried out by releasing a call connection mode from an EV-DO preference mode acting as a default mode during a predetermined time interval and switching the call connection mode to a 1× preference mode.

The method may comprise the step of: checking a call connection mode during the hybrid operation mode and monitoring only a 1× system when the call connection mode is set to a 1× preference mode.

The method may comprise the step of: checking a call connection mode upon packet call connection for data communication, and attempting to establish a packet call connection to the 1× system when the call connection mode is set to the 1× preference mode.

The call connection mode may be maintained despite changes in operation mode.

A failure in call connection with the EV-DO system may occur due to a failure in synchronization with a pilot channel of the EV-DO system.

In accordance with another aspect of the present invention, there is provided a hybrid mobile communication terminal including a first communication unit communicating with a first communication system capable of offering voice services and low-speed data transmission, a second communication unit communicating with a second communication system capable of offering high-speed data transmission, and a mode controller for controlling a switching operation between the first and second communication units, wherein the mode controller comprises a preference access setup unit which sets so that a data call connection to the first communication system is attempted during a predetermined time interval when the mode controller fails to establish a call connection with the second communication system in a hybrid operation mode in which the mode controller alternately attempts to access the first and second communication systems using the first and second communication units.

The preference access setup unit may comprise: a timer which sets up a time for a preference access to the second communication system to be blocked; and an access mode setup unit which sets a preference access mode to a second communication system preference mode by default, which switches the preference access mode to the first communication system upon failure in call connection to the second communication system, and which switches back the preference access mode to the second communication system upon expiration of the timer.

The hybrid mobile communication terminal may further comprise: an access controller for checking the access mode setup unit during the hybrid operation mode, and monitoring only the first communication system when the preference access mode is set to a first communication system preference mode.

The access controller may check the access mode setup unit upon packet call connection for data communication, and attempts to establish a packet call connection to the 1× system when the access mode setup unit is set to a 1× preference mode.

The first communication system may be a CDMA2000 1× system, and the second communication system may be a CDMA2000 1× EV-DO system.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph showing the monitoring period for a 1× system and an EV-DO system in a hybrid operation mode;

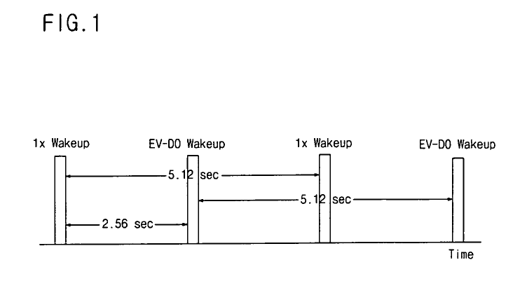

FIG. 2 is a block diagram showing a hybrid terminal in accordance with an embodiment of the present invention; and

FIG. 3 is a flowchart showing a method of controlling operation modes of a hybrid terminal in accordance with an embodiment of the present invention.

### DETAILED DESCRIPTION OF THE INVENTION

Exemplary embodiments of the present invention will now be described in detail with reference to the annexed drawings.

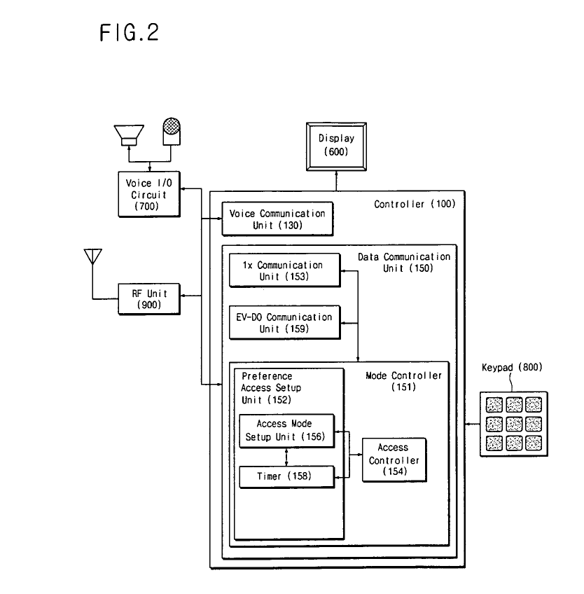

FIG. 2 is a block diagram showing a hybrid terminal in accordance with an embodiment of the present invention. The hybrid terminal comprises: a keypad 800; a display 600 for displaying menus and operation states thereon; a radio frequency (RF) unit 900 for extracting voice and data signals from RF signals transmitted/received over an antenna; a voice input/output (I/O) circuit 700 for inputting/outputting voice communication signals received from the RF unit 900 through a microphone or a speaker; and a controller 100 for controlling the overall system.

For example, a liquid crystal display (LCD) is used as the display 600. The RF unit 900 includes an antenna and an RF circuit to establish cell-based communication with a base station. The voice I/O circuit 700 converts digital voice data into an analog voice signal or vice versa, and includes additional circuits such as an audio amplifier circuit or filter as well known in the art.

A baseband circuit of the RF unit 900 and most circuits of the controller 100 are integrated into a commercially available single integrated circuit (IC) chip. The IC chip, which is usually called a mobile station modem (MSM) chip, includes dedicated hardware for communications, a digital signal processor, and a general-purpose microprocessor. Individual components of the controller 100 can be configured with dedicated hardware, dedicated software, or their combination. It should be noted that the present invention includes a variety of VLSI implementation methods.

A mobile communication terminal in accordance with the present invention comprises: a first communication unit communicating with a first communication system capable of offering voice services and low-speed data transmission; a second communication unit communicating with a second communication system capable of offering high-speed data transmission; and a mode controller for controlling a switching operation between the first and second communication units. In accordance with an embodiment of the present invention, the first communication system indicates a CDMA2000 1× service system, and the second communication system indicates a CDMA2000 1× EV-DO service system.

The controller 100 includes a voice communication unit 130 for processing voice communication and a data communication unit 150 for processing data communication. The data communication unit 150 includes a 1× communication unit 153, an EV-DO communication unit 159, and a mode controller 151. The 1× communication unit 153, which is a first communication unit, processes a connection to the 1× system. The EV-DO communication unit 159, which is a second communication unit, processes a connection to the EV-DO system. The mode controller 151 controls a switching operation between the 1× communication unit 153 and the EV-DO communication unit 159.

In accordance with a preferred embodiment of the present invention, the mode controller 151 further includes a preference access setup unit 152. When the mode controller 151 in the data communication unit 150 fails to establish a call connection with the second communication system during a hybrid operation mode in which the mode controller 151 alternately attempts to access the first communication system and the second communication system using the first communication unit and the second communication unit, the preference access setup unit 152 sets so that a data call connection to the first communication system is first attempted during a predetermined period.

In accordance with another preferred embodiment of the present invention, the preference access setup unit 152 includes a timer 158 and an access mode setup unit 156. The timer 158 sets up a time for a preference access to the second communication system to be blocked. In the case where the access mode setup unit 156 sets a preference access mode to a second communication system preference mode by default, the access mode setup unit 156 switches a preference access mode to the first communication system when the mode controller 151 fails to establish a call connection with the second communication system. Upon expiration of the timer 158, the access mode setup unit 156 switches back the preference access mode to the second communication system preference mode.

In accordance with another preferred embodiment of the present invention, the mode controller 151 further includes an access controller 154. The access controller 154 checks the access mode setup unit 156 in the hybrid operation mode. If the preference access mode in the access mode setup unit 156 is set to a first communication system preference mode, the access controller 154 monitors the 1× system only.

The access mode setup unit 156 may be a flag in a memory. A default value of the flag is set to indicate an EV-DO preference mode. The access controller 154 changes the flag to a 1× preference when an access to the EV-DO system is not possible in the hybrid operation mode, initiates and activates the timer 158. The access controller 154 checks the flag state of the access mode setup unit 156 during the hybrid operation mode. If the flag state is set to represent a 1× preference mode, the access controller 154 monitors the 1× system only. If the flag state is set to represent an EV-DO preference mode, the access controller 154 monitors both the 1× and EV-DO systems. Consequently, in the case when it is not possible to access the EV-DO system, the system-wakeup from an idle state decreases by half in frequency, resulting in reduced power consumption.

In accordance with another preferred embodiment of the present invention, the access controller 154 checks the access mode setup unit 156 upon packet call connection for data communication. If the access mode setup unit 156 is set to the 1× preference mode, the access controller 154 attempts to establish a packet call connection to the 1× system. If the access mode setup unit 156 is set to the EV-DO preference mode, the access controller 154 first attempts to access the EV-DO system. When the access controller 154 fails to access the EV-DO system, it attempts to access the 1× system. The access controller 154 fails to access the EV-DO system when it fails to search for a pilot channel, or to receive an overhead message from a designated control channel while a pilot signal has been acquired.

The timer 158 operates independently of any other in the mode controller 151. That is, once it starts to count, the timer continues to count while the mobile communication terminal switches to the 1× or EV-DO mode. Upon expiration of the timer 158, the access controller 154 changes a flag of the access mode setup unit 156 to the EV-DO mode which is a default value.

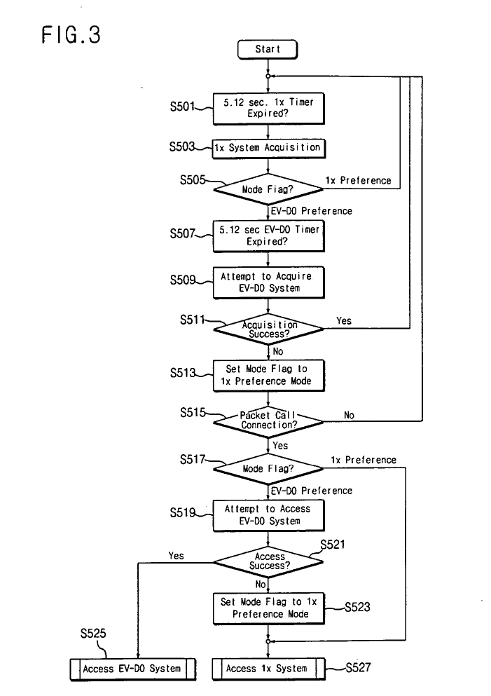

FIG. 3 is a flowchart showing a method of controlling operation modes of a hybrid terminal in accordance with an embodiment of the present invention.

When the hybrid terminal is switched from an IS-2000 slotted operation mode to the hybrid operation mode, the 1× timer having an operation period of 5.12 seconds (hereinafter referred to as “5.12 sec. 1× timer”) and the EV-DO timer having an operation period of 5.12 seconds (hereinafter referred to as “5.12 sec. EV-DO timer”) are initialized with intervals of 2.56 seconds and are initiated. The 1× timer and the EV-DO timer are periodically re-initialized. When the 5.12 sec. 1× timer is first expired (step S501), the hybrid terminal receives an overhead message from a paging channel acting as a control channel of the 1× system and performs initialization (step S503).

The access controller 154 in the hybrid terminal checks a mode flag of the access mode setup unit 156 (step S505). If the mode flag is set to represent “1× preference mode”, the access controller 154 returns to step S501 to monitor the 1× mode only. If the mode flag is set to represent “EV-DO preference mode”, the access controller 154, upon expiration of the EV-DO timer (step S507), attempts to acquire the EV-DO system by searching for a pilot channel of the EV-DO system and acquiring a pilot signal.

If the access controller 154 acquires the EV-DO system, it returns to step S501 to monitor both the 1× system and the EV-DO system. If the access controller 154 fails to acquire the EV-DO system, a mode flag of the access mode setup unit 156 is set to represent the 1× preference mode (step S513). However, since such an acquisition failure of the EV-DO system may occur temporarily, it is preferable that the above-mentioned mode conversion is carried out after the acquisition failure occurred several times.

If a packet call connection is requested in the hybrid operation mode in which both the 1× system and the EV-DO system are monitored (step S515), the access controller 154 in the hybrid terminal rechecks the mode flag (step S517). While the above-mentioned checking operation of the mode flag is shown in a flowchart of FIG. 3, the packet call connection request is actually made from the outside. Accordingly, the packet call connection request can be made at any one of the above-mentioned steps S501 to S513.

If the mode flag is set to represent the EV-DO preference mode, the access controller 154 attempts to access the EV-DO system. If a pilot channel is acquired and an overhead message is received from a control channel, a packet call is switched to the EV-DO system (step S525). If the access controller 154 fails to acquire the EV-DO system, it sets the mode flag to be the 1× preference mode, and establishes a packet call connection with the 1× system.

As apparent from the above description, a hybrid terminal according to the present invention monitors only a 1× system when it is unable to access an EV-DO system in a hybrid operation mode. Accordingly, it is possible to reduce the number of system-wakeups, resulting in reduced power consumption in an idle state.

Further, the hybrid terminal establishes a packet call with the 1× system without attempting to establish the packet call with the EV-DO system when it is not possible to access the EV-DO system upon packet call connection. Accordingly, it is possible to reduce time delay due to the call establishment.

While the present invention has been described with reference to exemplary embodiments thereof, it will be understood by those skilled in the art that various changes in form and details may be made therein without departing from the scope of the present invention as defined by the following claims.

What is claimed is:

1. A method of controlling call connection of a hybrid mobile communication terminal, comprising the step of:
attempting to establish a data call connection to a 1× mode during a predetermined time interval upon failure in call connection to an EV-DO (Evolution-Data Optimized) system during a hybrid operation mode.

2. The method of claim 1, wherein the step of attempting to connect to the 1× mode is carried out by releasing a call connection mode from an EV-DO preference mode acting as a default mode during a predetermined time interval and switching the call connection mode to a 1× preference mode.

3. The method of claim 2, comprising the step of:
checking a call connection mode during the hybrid operation mode and monitoring only a 1× system when the call connection mode is set to a 1× preference mode.

4. The method of claim 3, comprising the step of:
checking a call connection mode upon packet call connection for data communication, and attempting to establish a packet call connection to the 1× system when the call connection mode is set to the 1× preference mode.

5. The method of claim 4, wherein the call connection mode is maintained despite changes in operation mode.

6. The method of claim 4, wherein a failure in call connection with the EV-DO system occurs due to a failure in synchronization with a pilot channel of the EV-DO system.

7. A hybrid mobile communication terminal including a first communication unit communicating with a first communication system capable of offering voice services and low-speed data transmission, a second communication unit communicating with a second communication system capable of offering high-speed data transmission, and a mode controller for controlling a switching operation between the first and second communication units, wherein the mode controller includes a preference access setup unit which sets so that a data call connection to the first communication system is attempted during a predetermined time interval when the mode controller fails to establish a call connection with the second communication system in a hybrid operation mode in which the mode controller alternately attempts to access the first and second communication systems using the first and second communication units.

8. The hybrid mobile communication terminal of claim 7, wherein the preference access setup unit comprises:
a timer which sets up a time for a preference access to the second communication system to be blocked; and
an access mode setup unit which sets a preference access mode to a second communication system preference mode by default, which switches the preference access mode to the first communication system upon failure in call connection to the second communication system, and which switches back the preference access mode to the second communication system preference mode upon expiration of the timer.

9. The hybrid mobile communication terminal of claim 8, further comprising:
an access controller for checking the access mode setup unit during the hybrid operation mode, and monitoring only the first communication system when the preference access mode is set to a first communication system preference mode.

10. The hybrid mobile communication terminal of claim 9, wherein the access controller checks the access mode setup unit upon packet call connection for data communication, and attempts to establish a packet call connection to the 1× system when the access mode setup unit is set to a 1× preference mode.

11. The hybrid mobile communication terminal of claim 10, wherein the first communication system is a CDMA2000 1× system, and the second communication system is a CDMA2000 1× EV-DO system.
